(19) United States
(12) Patent Application Publication
(10) Pub. No.: US 2006/0108764 A1
(43) Pub. Date: May 25, 2006

(54) Chassis suspension

(76) Inventor: Michael Bidlingmaier, Schwabisch Gmund (DE)

Correspondence Address: KLAUS J. BACH, 4407 TWIN OAKS DRIVE, MURRYSVILLE, PA, 15668, US

(21) Appl. No.: 11/228,040

(22) Filed: Sep. 15, 2005

Related U.S. Application Data
(63) Continuation-in-part of application No. PCT/EP04/00186, filed on Jan. 14, 2002.

(30) Foreign Application Priority Data
Mar. 15, 2003 (DE) 103 11 442.4

(51) Int. Cl. B60G 11/00; B60G 21/055

(52) U.S. Cl. 280/124.164; 280/124.169; 267/242

(57) ABSTRACT

In a chassis suspension comprising a spring structure for oscillation isolation, which is mounted at least at one end in a bearing and provided with a spring movement limiting device, a buckling element forming a support for the spring structure is arranged in a housing consisting of two telescopic cylinders providing for longitudinal and transverse movement limits for the buckling element.

### This is a Continuation-In-Part Application of international application PCT/EP04/000156 filed Jan. 14, 2003 and claiming the priority of German application 103 11 442.1 filed Mar. 15, 2003.

### BACKGROUND OF THE INVENTION

The invention relates to a chassis suspension comprising a spring which is pre-tensioned at one end and a buckling element is provided for limiting the spring movement.

Moving parts on machines, appliances and vehicles generate oscillations and consequently also undesirable noises and vibrations. A transmission of vibrations can either be insulated or damped. Mechanical vibrations arise where an oscillatory system, that is to say a mass is supported by a spring means. The mass constitutes the store for kinetic energy and the spring the store for potential energy. For assemblies subjected to highly intense oscillations, single or double elastic mountings are not sufficient for attenuating the oscillations, and adverse high spring rigidities have to be selected for the support of heavy masses.

Critical parameters for the oscillation-attenuating action of an elastic support arrangement are the rigidity of the springs used and the effective mass of the elastically supported system.

DE 199 58 178 C1 discloses a spring damper strut for a vehicle wheel, in which the support element used is a steel spring which therefore has to have high spring stiffness. For a comfortable spring suspension, however, the spring should be as soft as possible, particularly when used in an active chassis.

DE 198 18 786 A1 discloses a device for the elastic support of machines, wherein buckling bars with elements limiting their deflection are arranged parallel to a spring element between a foundation and a machine bottom.

It is the object of the present invention to provide a chassis suspension having a spring support structure with improved oscillation-attenuating properties and with a relatively low spring stiffness.

### SUMMARY OF THE INVENTION

In a chassis suspension comprising a spring structure for oscillation isolation, which is mounted at least at one end in a bearing and provided with a spring movement limiting device, a buckling element forming a support for the spring structure is arranged in a housing consisting of two telescopic cylinders providing for longitudinal and transverse movement limits for the buckling element.

According to the invention, the support used in the suspension is a buckling bar. The advantage of this is that the “mass-carrying” or support functions and the “oscillation-attenuating” functions are separated and are assumed by different components. The carrying capacity of the one element can therefore be set essentially independently of the spring stiffness of the other element.

The invention will become more readily apparent from the following description of a particular embodiment thereof with reference to the accompanying drawings.

### BRIEF DESCRIPTION OF THE DRAWINGS

FIG. 1 shows a characteristic curve of the pressure force against the spring excursion of a buckling bar as a buckling element,

FIG. 2 shows a preferred parallel arrangement of a buckling element and a spring element,

FIG. 3 shows a preferred arrangement with a buckling element in a housing with length adjustment,

FIG. 4 shows schematically a preferred off-highway vehicle suspension, and

FIG. 5 shows a preferred head spring and support structure with buckling elements.

### DETAILED DESCRIPTION OF PREFERRED EMBODIMENT

When a pressure force acts on a bar, the bar force rises sharply, along with slight deformation, and, when a buckling force F_{K} is exceeded, remains constant over a large deformation range. Such a bar is called as a buckling bar or buckling element. When it is subjected to a compression stress, the bar buckles laterally when the buckling force F_{K} is reached. As long as the force is lower than the buckling force F_{K}, the buckling bar remains straight. When the buckling force F_{K} is exceeded, the buckling bar buckles immediately. Until it buckles, the force profile of the buckling bar is similar to the force profile of an elastic spring, in which the length change in the axial direction is proportional to the acting force. After buckling, its rigidity approaches zero.

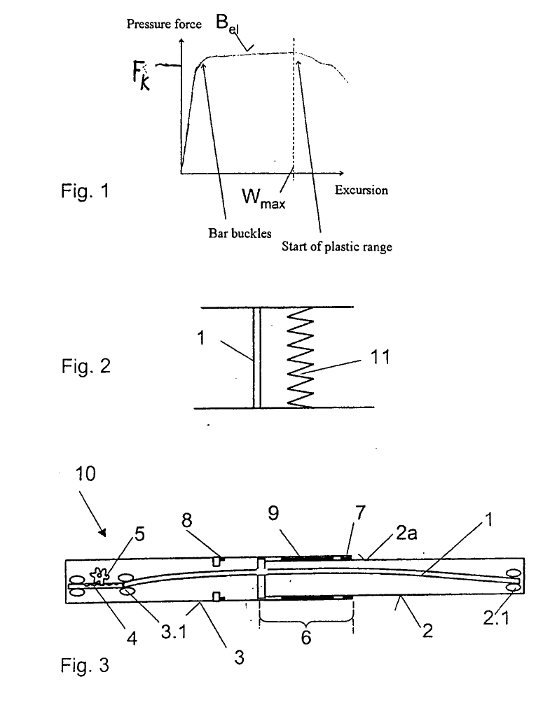

FIG. 1 shows diagrammatically a characteristic curve of the pressure force over the axially executed excursion of a buckling bar. When low pressure forces act on the buckling bar, the latter behaves in the same way as an elastic spring: the change in length of the bar excursion is proportional to the force acting on the buckling bar, the spring stiffness corresponding to the modulus of elasticity. As soon as the acting force reaches the buckling force F_{K}, the buckling bar buckles. This can be seen in the graph of the characteristic curve range Bₑₗ parallel to the excursion axis. This range Bₑₗ characterizes the elastic range of the buckling bar. The buckling force F_{K}, here, is independent of the excursion, thus corresponding to an infinitely low spring stiffness of the buckling bar. When the elastic range Bₑₗ is exceeded at Wₘₐₓ, plastic deformation occurs and the buckling bar fails.

In the following figures, identical elements or functionally identical elements are designated in each case by the same reference symbol.

In the chassis suspension according to the invention, a buckling element 1 is provided which forms a support element of a spring device for the chassis. The spring device preferably comprises an oscillatory element 11 arranged parallel to the buckling element 1 as shown in FIG. 2. This arrangement has the advantage that the “load-carrying” and “springing” functions are separated from one another. The spring rigidity of the oscillatory element 11 therefore does not have to be coordinated directly with the mass to be supported. In a first embodiment, the oscillatory element 11 is an elastomer. This configuration is suitable for a top bearing. In this combination, the spring stiffness of the top bearing is no longer determined directly by the maximum load which is determined by the mass to be supported.

In a further embodiment, the oscillatory element 11 is a steel spring. In this combination, a desired, preferably low, spring stiffness can provided in a controlled way. In this case, the spring stiffness may, in a first approximation, be independent of the basic load, that is, the mass to be supported.

In an other embodiment, the oscillatory element 11 is a pneumatic spring. In a preferred embodiment, the oscillatory element 11 is an active servomotor. The advantage of this is that a servo motor, in particular a linear motor, provides only additionally desired forces and, with an appropriate control during relative movements of the servomotor, no undesirable reaction forces are generated. The static basic load of a mass to be carried is supported by the buckling element 1, while dynamic loads can be controllably accommodated by the servomotor. This combination makes it possible, at a relatively low energy consumption, to have a high control potential of the actuator, particularly in an active chassis. The arrangement with a servomotor, in particular with a linear motor, acts as a virtually ideal force controller which accommodates all the dynamic loads, but at the same time, in the event of faults which cannot be controlled, is infinitely soft. This also applies approximately to a pneumatic spring used as an oscillatory element 11. In addition, in combination with a pneumatic spring, load leveling can be implemented in a simple way.

FIG. 3 shows a preferred arrangement of a suspension with a buckling element 1. The buckling element 1 is arranged in a housing 10. The housing 10 with the buckling element 1 is preferably arranged parallel to a pneumatic spring. The housing 10 is designed as a telescopic cylinder, in which a first cylinder 2 and a second cylinder 3 are inserted one into the other in such a way that they form an overlap region 6. A bearing 9, in particular a slide bearing, and an extension stop 7 are arranged in the overlap region 6 between the two cylinders 2, 3. The buckling element 1 is tension-mounted inside the housing 10 with a first end supported in a first bearing 2.1 in the first cylinder 2 and with a second end supported in a second bearing 3.1 in the second cylinder 3. In the position of rest, the buckling element 1 assumes a defined length, wherein the housing 10 consequently has a length L₀. In the position of rest, the buckling element is preferably already buckled and has a bulge disposed approximately in the middle. The housing extension stop 7 has the effect that the buckling element remains buckled and does not fall back into the range of the linear characteristic curves. An axial pressure load along the longitudinal axis of the housing 10 leads to a compression of the buckling element 1 and consequently to a shortening of the housing 10. The difference between the length in the position of rest and the length under load corresponds to the excursion in FIG. 1 in the elastic range Bₑₗ. A compression stop structure 8, preferably inside the second cylinder 3, prevents an inadmissible compression of the buckling element 1 and thus limits the elastic range Bₑₗ of the buckling element 1 to the value Wₘₐₓ. As long as the buckling element 1 remains in the elastic range Bₑₗ, a constant force F_{K} can be generated by the arrangement which is independently of the excursion that is it is essentially constant.

In addition, the diameter of the first cylinder 2 may be dimensioned such that, in the region of the bulge of the buckling element 1, a boundary wall 2a of the cylinder 2 has, with respect to the buckling element 1, a clearance which is smaller than a maximum permissible lateral deflection which occurs in the event of the maximum length change Wₘₐₓ in the axial direction in the elastic range Bₑₗ of the buckling element 1. As a result of the contact of the buckling element 1 with the wall 2a, a progressive characteristic curve of the buckling element 1 can be established.

The buckling force F_{K} can be changed in a controlled way by means of a change in the length of the buckling element 1. For this purpose, at one end 4 of the buckling element 1, outside the tension-mounted region, indentations are provided, which interact with an actuating means 5, in particular a gearwheel, so that the buckling element 1 is movable longitudinally at this end 4. The actuating means is advantageously electrically adjustable. The end 4 having the indentations is expediently always located in the unloaded region of the buckling element 1. Load relief by means of a roller guide of the bearing 2.1 is expediently implemented.

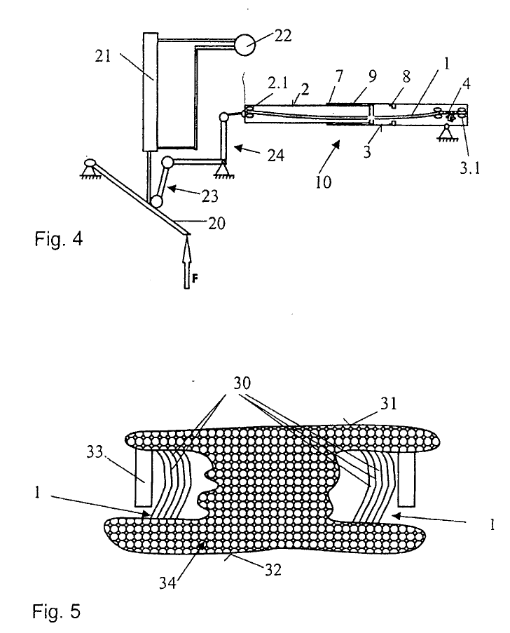

FIG. 4 shows diagrammatically a detail of a preferred spring device for an off-highway vehicle. A buckling element 1 is arranged in a housing 10 designed as a telescopic cylinder. The housing 10 is preferably accommodated in a sill of the vehicle frame. A wheel, not illustrated, exerts a wheel load F on a transverse link 20, on which an active damper 21 equipped with a motor/pump unit 22 is articulated. A post 23 is supported on the transverse wheel support arm 20. The buckling element 1 in the housing 10 is articulated via a known pushrod reversal structure 24, as it is known. Maximum forces can be accommodated via the tension and compression abutments 7, 8. Leveling can be brought about via an adjustment of the length of the buckling element 1, for example at its end 4, as described in FIG. 3. This arrangement has the advantage that long spring excursions with low spring stiffness are possible.

FIG. 5 shows a preferred embodiment of a support structure, particularly of a top bearing. The buckling element 1 is formed by a plurality of fibers 30. The fibers 30 are preferably arranged annularly, and the fiber ring thus formed is tension-mounted in the axial direction in each case at a first rim 31 and at a second rim 32. Alternatively, the fibers 30 may also be distributed in the form of clusters.

A ring 33 is arranged as an end abutment in the axial direction coaxially to the fiber ring. An elastomeric bearing 34 is provided coaxially to the fiber ring. Alternatively, the fibers 30 surround the elastomeric bearing 34 at least in regions. The fibers 30 may comprise plastic fibers, carbon fibers and/or ceramic fibers.

The design of top bearings and chassis bearings is determined predominantly by a required useful life and the basic load to be carried. Normally, for this reason, it is necessary to provide a spring stiffness which is four times as high as is actually desired on the basis of comfort requirements.

In a preferred embodiment of a top bearing, the fibers 30 consist of aramide fibers and annularly surround an elastomeric bearing 34. The elastomeric bearing 34 located within the fiber ring can then have a desired defined low spring stiffness. The aramide fibers accommodate the load in the buckled state and are cast into the elastomeric bearing 34 at the upper and the lower rims 31, 32. A metal ring 33 serves as an end abutment and is expediently likewise cast into the upper rim 31.

What is claimed is:

1. A chassis suspension comprising a spring device for oscillation attenuation,
the spring device including a buckling element (1) supported at least at one end thereof in a bearing (2.1, 3.1) and forming a support structure for supporting said chassis, and
limitation means (7, 8) for limiting spring movement of the buckling element (1),
said buckling element (1) being arranged in a housing (10) which consists of two telescopic cylinders (2, 3).

2. The chassis suspension as claimed in claim 1, wherein the spring device comprises an oscillatory element (11) arranged parallel to the buckling element (1).

3. The chassis suspension as claimed in claim 2, wherein the oscillatory element (11) is an elastomer.

4. The suspension device as claimed in claim 2, wherein the oscillatory element (11) is a steel spring.

5. The suspension device as claimed in claim 2, wherein the oscillatory element (11) is a pneumatic spring.

6. The suspension device as claimed in claim 2, wherein the oscillatory element (11) is an active servomotor.

7. The suspension device as claimed in claim 1, wherein a length adjustment (5) desired for changing the length of the buckling element (1) is provided.

8. The suspension device as claimed in claim 1, wherein the two telescopic cylinders (2, 3) are inserted one into the other, and a tension abutment (7) is provided between the two sub-cylinders (2, 3).

9. The suspension device as claimed in claim 1, wherein said housing (10) includes at each end thereof a bearing (2.1, 3.1), by which the buckling element (1) is mounted.

10. The suspension device as claimed in claim 1, wherein the housing (10) has a boundary wall (2a) including, with respect to a bulge of the buckling element (1), a certain clearance which is smaller than a lateral deflection of the buckling element (1) so as to limit deflection of the buckling element beyond the maximum permissible deflection (Wₘₐₓ) in the elastic range (Bₑₗ).

11. The suspension device as claimed in claim 1, wherein one of the limitation means is a compression abutment (8) provided in one of the cylinders (2, 3).

12. The suspension device as claimed in claim 1, wherein the buckling element (1) has at one end (4), outside the mounted region, indentations which interact with an actuating means (5) in such a way that the buckling element (1) is movable longitudinally.

13. The suspension device as claimed in claim 12, wherein the actuating means (5) includes a roller guide which is supported by a bearing (3.1) adjacent to the indentations.

14. A chassis suspension comprising a spring device for oscillation attenuation, said spring device including a buckling element (1) comprising a plurality of fibers (30) disposed around an elastomer bearing structure (34) and forming a support structure for supporting said chassis.

15. The suspension as claimed in claim 14, wherein the fibers (30) are arranged annularly, so as to form a fiber ring and are tension-mounted in the axial direction at an upper and a lower rim (31, 32) of the elastomer bearing structure (34).

16. The suspension as claimed in claim 15, wherein a ring (33) is provided so as to extend around the annularly arranged fibers (30) as an end abutment in the axial direction and also a buckling limiting structure.
